(19) United States
(12) Patent Application Publication
(10) Pub. No.: US 2009/0197089 A1
(43) Pub. Date: Aug. 6, 2009

(54) Compact laminate having powder coated surface

(76) Inventor: Joel Klippert, Puyallup, WA (US)

Correspondence Address: CHARLES J RUPNICK, PO BOX 46752, SEATTLE, WA, 98146, US

(21) Appl. No.: 12/313,225

(22) Filed: Nov. 18, 2008

Related U.S. Application Data
(63) Continuation-in-part of application No. 12/012,081, filed on Jan. 31, 2008.

(51) Int. Cl. B32B 27/10; B32B 9/00; B05D 7/24; B32B 38/08; B32B 38/00

(52) U.S. Cl. 428/413; 428/537.5; 428/481; 428/511; 427/180; 427/474; 156/60; 156/279

(57) ABSTRACT

A compact laminated assembly based upon a saturation grade paper made using a grass fiber or grass/wood fiber blend, instead of the conventional wood fibers from trees. A plurality of the grass paper sheets are substantially impregnated using a thermosetting resin and stacked in a superimposed relationship. The assembled stack of resin impregnated paper sheets are heat and pressure consolidated into a substantially homogenous monolithic mass with the thermosetting resin being substantially completely cured. A film of a substantially completely cured solid powder coating composition is laminated to at least a portion of an outer surface of the compact laminated assembly.

This application is a Continuation-in-part of co-pending U.S. patent application Ser. No. 12/012,081 entitled, “COMPACT LAMINATE” filed in the name of the same inventor, Joel Klippert, on Jan. 31, 2008, which is incorporated herein by reference.

### FIELD OF THE INVENTION

The present invention relates generally to both low and high pressure bio-composite surface resin laminate materials and methods for producing same, and in particular to resin laminates formed of wood or grass fiber and blends of grass fiber with recycled wood fiber, including and having a film of a substantially completely cured solid powder coating composition laminated to at least a portion of an outer surface of the resin laminate.

### BACKGROUND OF THE INVENTION

Compact laminates are generally well-known as made up of multiple layers of kraft paper impregnated with thermosetting phenolic resin sandwiched between decor papers impregnated with special high-abrasion-resistant melamine resins. These components are pressed at a temperature and pressure at which a chemical and physical transformation known as polymerization occurs where the components are melded into an extremely strong, solid, homogenous panel with superior wear-resistance, but suitable for internal use only.

Both low pressure and high pressure resin methods are generally well-known for producing compact laminates. One low pressure resin laminate is disclosed by DeLapp in U.S. Pat. No. 4,109,043, “Low Pressure Melamine Resin Laminates” issued Aug. 22, 1978, which is incorporated herein by reference, which discloses a heat and pressure consolidated structure formed of a self-supporting substrate in superimposed relationship with a decorative alpha-cellulose paper sheet that is impregnated with a resin composition of a mixture of a melamine/formaldehyde resin syrup, an elastomer comprising an ethylene/vinyl chloride copolymer containing amide groups, a butadiene/acrylonitrile copolymer containing carboxyl groups or a polyurethane resin containing carboxyl groups and an alkylene polyamine.

As disclosed by DeLapp, the compositions may be used to produce a transparent system, for example, in the production of decorative panels of a specific color or having a specific decorative pattern or design on the decorative layer.

As also disclosed by DeLapp, the decorative papers from which the low-pressure decorative panels are produced are made from bleached wood pulp which is high, at least about 60%, in alpha cellulose content.

The decorated paper layer may be placed on both sides or only on one side of the self-supporting substrate when panels are being produced. If the decorative sheet is placed only on one side of the substrate, a so-called balance sheet, i.e., a melamine/formaldehyde resin impregnated paper sheet, e.g., of kraft or other paper, sometimes called a cabinet liner, can be placed on the other side in order to prevent the resultant panel from warping during pressing. Typical release sheets can be applied to both the decorative paper layer and the balance sheet to prevent the press plate from sticking thereto during pressing.

DeLapp teaches that various finishes may be applied to the decorative panels. For example, the surface may be rendered glossy by using a highly polished press plate, matte by interposing a texturizing release sheet between the press plate and the decorative sheet or embossed by using an etched press plate.

In U.S. Pat. No. 4,128,696, “Low Pressure Melamine Resin Laminates” issued Dec. 5, 1978, which is incorporated herein by reference, Goebel, et al. discloses a heat and pressure consolidated panel composed of, in superimposed relationship, (A) a self-supporting substrate, and (B) a decorative alpha-cellulose paper sheet impregnated with a composition formed of (1) a blend of an aqueous melamine/formaldehyde resin solution and from about 2% to about 20.0% of an ethylene glycol or (2) an aqueous solution of the resinous reaction product of melamine, formaldehyde and from about 2.0% to about 20.0% of an ethylene glycol.

According to Goebel, et al., these panels are a single sheet of melamine/formaldehyde resin impregnated decorative paper which is bonded under heat and pressure to a substrate, usually particle-board, of about ¼ to about 1 inch in thickness. Goebel, et al. also discloses that these products, because they are normally produced at low pressures, i.e., about 175-to-225 psi to as much as 300 psi, and low temperatures, i.e., about 325 degree F. to 350 degree F., at very short cure cycles in the range of 2 to 3 minutes, are relatively inexpensive and have a good appearance and stain resistance.

Alternatively, high pressure resin laminates and methods of producing same are disclosed by Albrinck, et al. in U.S. Pat. No. 5,288,540, “Damage Resistant Decorative Laminate Having Excellent Appearance And Cleanability And Methods Of Producing Same” issued Feb. 22, 1994, which is incorporated herein by reference, which relates to damage resistant, decorative laminates employing a decorative sheet saturated with a melamine/formaldehyde resin coating incorporating abrasive materials and methods of producing the same. See, also, U.S. Pat. No. 4,255,480, “Abrasion-Resistant Laminate” issued Mar. 10, 1981, which is incorporated herein by reference, in which Scher, et al. disclose an abrasion-resistant laminate is prepared by providing an ultra thin coating of mineral particles and micro crystalline cellulose on the surface of conventional printed paper, followed by impregnating the paper with a conventional laminating resin, and then using the print paper so obtained in a laminating process without the necessity of using an overlay sheet.

As disclosed by both Albrinck, et al. and Scher, et al., conventional high pressure decorative laminates are produced by stacking and curing under heat and pressure a plurality of layers of paper impregnated with various synthetic thermosetting resins. High pressure decorative laminates consist of two essential layers: a core layer and a surface layer. The core layer constitutes a bottom or supporting layer onto which the other layer is bonded. In normal high-pressure laminate manufacture, the core layer consists of a plurality of cellulosic sheets, e.g. three to eight, core sheets.

As further disclosed by Albrinck, et al., other laminating resins commonly used for the core layer include phenolic, amino, epoxy, polyester, silicone, and diallyl phthalate resins to name a few. The industrially preferred laminating resin for decorative laminates is a phenolic resin made from the reaction of phenols with formaldehyde. Placed above the core layer is a decorative layer which is generally an alpha cellulose pigmented paper containing a print, pattern design or solid color that has been impregnated with a thermosetting resin, such as a melamine/formaldehyde resin. The cured thermosetting resins are colorless and resistant to light; they are resistant to a variety of solvents and stains; and their heat resistance make them resistant to burning cigarettes, boiling water and heated containers up to about 325 degree F.

When the decorative layer of the laminate is a printed pattern, it is often covered with an overlay as it is commonly referred to, which is a high-quality alpha cellulose paper impregnated with a melamine/formaldehyde resin. This overlay is almost transparent and protects the decorative print from external abuse such as abrasive wear and tear, harsh chemicals, burns, spills and the like. It is primarily the melamine/formaldehyde resin which accounts for these protective properties of the laminate. The alpha-cellulose paper acts as a translucent carrier for the water-thin resin, imparts strength to the rather brittle melamine/formaldehyde resin, maintains a uniform resin thickness in the overlay by acting as a shim, and controls resin flow.

The core sheets are generally made from a kraft paper of about 90-125 pound ream weight. Kraft paper is manufactured from normal high quality soft wood sulphate pulp, as disclosed by Landqvist, et al. in U.S. Pat. No. 4,741,376, “Manufacturing Of Kraft Paper” issued May 3, 1988, which is incorporated herein by reference. Prior to stacking, the kraft paper is impregnated with a laminating resin such as a water-alcohol solution of phenol/formaldehyde resole, dried and partially cured in a hot air oven, and finally cut into sheets. The print sheet is a high quality, 50-125 ream weight, pigment filled, alpha cellulose paper that has been impregnated with a water-alcohol solution of melamine/formaldehyde resin, dried and partially cured, and finally cut into sheets. The print sheet, prior to impregnation with the resin, usually has been printed with a decorative design, or with a photogravure reproduction of natural materials, such as wood, marble, leather, etc.

The overlay sheet is almost invariably used when the print or pattern sheet has a surface printing in order to protect the printing from abrasive wear. The overlay sheet is a high quality bleached wood pulp paper of high alpha cellulose content, typically of about 20-30 pounds ream weight, that is also impregnated with melamine/formaldehyde resin in a manner similar to that used for the print sheet, except that a greater amount of resin per unit weight of paper is used. The individual pattern sheets are stacked in the manner indicated above and, if six sheets of impregnated core paper are used, there results a finished laminate having a thickness of about 50 mils, although a different number of sheets can be used to provide thicker or thinner laminates.

The core layer, decorative layer and the overlay surface layer (when present) are stacked from the bottom up in a superimposed relationship, between steel press plates and subjected to heat, pressure and temperature for a time period sufficient to consolidate the laminate and to cure the laminating resins impregnating the respective layers. The elevated temperature and pressure actually cause the impregnated resins within the sheets to flow, cure and consolidate the sheets into a unitary laminated mass referred to in the art as a decorative high-pressure laminate. At the completion of the laminating operation, the backs of the laminates are sanded to permit gluing to particle board, plywood or other substrates. The glued, laminate surfaced panels are used as surfacings for counter tops, table tops, furniture, store fixtures and the like. However, these conventional high pressure laminates can be easily damaged by scraping or marring caused by objects sliding across the surface of the laminate.

A number of variations of the above-described general processes are known, particularly those operations designed to obtain special effects in appearance and texture. Also various curing cycles are possible and, in fact, sometimes other resin systems are used as well.

As illustrated by these and other prior art patents, both high-pressure and low-pressure decorative resin laminate panels and known methods for producing same are limited to a decorative paper layer stacked in a superimposed relationship with a core layer and an optional protective surface layer. The core layers are generally made from a kraft paper manufactured from normal high quality soft wood sulphate pulp, and the decorative papers are made from bleached wood pulp. Known resin laminate panels are thus limited to products made from wood fibers.

According to Scher, et al., it is desirable to be able to provide the characteristics of an abrasion-resistant high-pressure laminate, but without using an overlay, for several reasons. Overlay adds substantial raw material costs to the manufacture of laminates, both the cost of the overlay paper itself, the cost of the resin used to impregnate the overlay paper and the in-process and handling of losses of these materials.

The overlay, by imposing an intermediate layer of substantial thickness between the print sheet and the eyes of the viewer, detracts significantly from the desired visual clarity of the pattern. The cellulose fibers used to make overlay paper have a refractive index close to that of cured melamine/formaldehyde resin. The fibers are therefore almost invisible in the cured laminate, and permit the printed pattern to be seen with very little attenuation. However, modern printing techniques are making available very accurate reproductions of natural materials, particularly various wood veneer species. As these printed reproductions approach in appearance the natural veneer, even small amounts of haze or blur introduced by the overlay paper are disturbing visually and destroy much of the realism desired by the user.

Furthermore, the overlay contributes to the rejection rate of the laminate products produced. The impregnated, dry overlay sheet tends to attract small dirt particles because it develops static electricity charges during drying. This dirt is hard to detect and remove before laminating, and results in spoiled laminate sheets that cannot be reprocessed. In addition, the impregnated dried overlay is brittle and hard to handle without breakage. Broken pieces are accidentally trapped on the surface of the overlay and also result in visually defective sheets.

Additionally, laminates containing an overlay, particularly those having a relatively high surface gloss, have a tendency to become dull very quickly when subjected even to only moderate abrasive wear. This is understandably unacceptable where glossy laminates are desired.

Although as discussed herein above, Scher, et al. also disclose an abrasion-resistant high-pressure laminate without the necessity of using an overlay sheet, overlay sheets remain common practice.

### SUMMARY OF THE INVENTION

The present invention is a novel thermal set resin compact laminate product using a grass fiber, such as a bamboo fiber, instead of the conventional wood fibers from trees. The bamboo grass fiber is much longer and more absorbent than traditional tree fiber, characteristics which provide the unexpected results of greater dimensional stability and a stronger internal bond due to an increased resin saturation into the core over conventional wood fiber alone. The novel paper product of the present invention utilizes either 100% bamboo or other grass fibers, a rapidly renewable resource, or a 50/50 blend of grass and recycled wood fiber, including wood fiber from recycled paper products. These results are unexpected because grass fibers, including bamboo fibers, have not previously been used in thermal set resin paper products.

According to one aspect of the invention, the novel thermal set resin paper product is based upon a novel saturation grade paper made using the grass fiber or grass/wood fiber blend. The novel paper is saturated with a thermosetting resin, including but not limited to any phenolic, epoxy, melamine or polyester laminating resin. The laminating resin is optionally an environmentally friendly 100% water-based melamine resin.

After the paper fiber is treated with resin, the product is pressed and bonded together under heat and pressure. According to one aspect of the invention, the heat and pressure are applied using a high pressure press at approximately 1,000 psi to 1,200 psi at approximately 275 degrees F. to cure the resin, then using a cooling cycle the press is cooled to about 100 degrees F. while the product is still under pressure. Continued application of the pressure retards warp while cooling and ensures the resultant panels are flat. When the panel product is manufactured utilizing a low pressure press without a cooling cycle, more resin is used than in the comparable high pressure process, and pressures between about 200 psi and 300 psi are utilized. The laminated panel product is optionally removed hot from the press, and stacked on a cooling slab under heavy load to maintain flatness, while being cooled with fans.

After cooling, the resultant laminates are separated, trimmed and packaged.

According to other aspects of the invention, a novel powder coated consolidated laminated panel is formed of a plurality of paper sheets each impregnated with a substantially completely cured resinous composition, assembled in superimposed relationship, and heat and pressure consolidated into a consolidated laminated panel with a film of a substantially completely cured solid powder coating composition laminated to at least a portion of its outer surface.

The consolidated laminated panel is optionally of the type disclosed herein that includes one or more of the impregnated grass or grass blend sheet sheets as disclosed herein, such as grass or grass blend sheet sheets formed of a grass fiber, instead of the conventional wood fibers from trees. The grass fiber is optionally a bamboo fiber as disclosed herein.

A novel method of forming a powder coated consolidated laminated panel is disclosed herein. By example and without limitation, the method includes applying a film of a solid powder coating composition to at least a portion of an outer surface of a consolidated laminated panel. According to one embodiment, the solid powder coating composition of a type that is substantially completely curable at temperatures less than about 500 degree F. Accordingly, the method includes substantially completely curing the powder coating composition at an elevated temperature less than about 500 degree F., and subsequently cooling the compact laminate with the powder coated applied thereto.

After application to the substrate, the applied powder coating is cured, generally at a temperature of 200 to 500 degree F. (93 to 260 degree C.), but may be in the temperature range of about 250 to 400 degree F. (121 to 204 degree C.). Low curing temperatures of wood substrates is generally less than 325 degree F. (163 degree C.), but may be less than 250 degree F. (121 degree C.). Another advantage of the curable compositions is their ability to produce matte and low gloss finishes over a wide range of curing temperatures. For example, such finishes may be produced over the entire temperature range of 250 degree F. to 400 degree F.

Other aspects of the invention are detailed herein.

### DETAILED DESCRIPTION OF PREFERRED EMBODIMENT

A novel compact laminate is disclosed that utilizes a novel saturation grade paper made from a grass fiber, such as a bamboo or other grass fiber, either alone or in a blend, e.g., about a 50/50 blend, of grass and wood fiber. The wood fiber is either a virgin wood fiber or a recycled wood fiber, for example a wood fiber salvaged from demolition sites, or wood fiber salvaged from recycled paper and recycled paper products. The grass fiber is much longer and more absorbent than traditional tree fiber. These are characteristics that produce unexpected useful result when used in the present compact laminate. The longer grass fiber unexpectedly results in greater dimensional stability over the shorter traditional tree fiber. The longer grass fiber unexpectedly results in increased resin saturation into the product core over the shorter traditional tree fiber, which increased resin saturation results in a stronger internal bond than is typical of conventional compact laminates traditional tree fiber. The use of grass fiber thus unexpectedly permits thicker compact laminates than are possible when the paper is prepared from traditional tree fiber. Thus, although the novel compact laminate disclosed herein is optionally produced as a thin decorative surface layer and assembled in superimposed relationship with a self-supporting bottom or substrate layer such as particle board or plywood substrates or the conventional cores layer described herein, it is optionally produced in much thicker sections capable of standing alone, without the necessity of the bottom or supporting core layer onto which the conventional decorative layer is traditionally bonded. Accordingly, the novel compact laminate disclosed herein is optionally produced as thin decorative surface layers from about 0.040 inch thick through thicker self-supporting panels of ¼ inch thickness up to 1½ inch thickness or even thicker. Thus, while the novel compact laminate disclosed herein is optionally utilized as a decorative surface layer in the traditional manner, it is also used as a stand-alone product for counter tops, table tops, furniture, store fixtures and the like.

Furthermore, the composition of the novel compact laminate disclosed herein is a homogeneous composition having a substantially constant composition throughout any thickness. Therefore, abrasion resistance is not a factor. The decorative appearance and texture of prior art compact laminates are present only in the thin decorative sheet that is easily damaged and thereafter irreparable. Any damage to the topmost decorative sheet exposes the phenolic resin core similarly to the way a scratch in the paint of an automobile exposes the metal beneath. Except in the case of conventional compact laminates, the damage cannot be repaired sanding and repainting, but only by replacing the entire panel. For this reason, prior art compact laminates superimpose the clear protective layer to protect the integrity of the delicate decorative layer. Else, additives are supplied in the laminating resin syrup to improve abrasion resistance.

In contrast to the common practices of conventional compact laminates, the composition of the novel compact laminates disclosed herein is produced without the abrasion-resistant overlay surface layer or resin additives usually needed for protection against external abuse such as abrasive wear and tear, harsh chemicals, burns, spills and the like. Rather, the homogeneous nature of the compact laminates disclosed herein ensures that, in contrast to prior art compact laminates, the surface can be cut, routed, sanded and finished with typical woodworking tools, much like butcher block type surfaces, so that scratches, dents, burns and other surface damage can be repaired, for example, by sanding and refinishing. Furthermore, the homogeneous nature of the compact laminates disclosed herein ensures that digs, gouges, cuts and tears in the surface expose only the same color and texture extant in the surface layer so that damage, if it does occur, is not so readily apparent. Accordingly, the negative impacts of the overlay sheet typical of the prior art products are completely eliminated in the present compact laminate, without sacrificing the desirable durable qualities.

The above results are unexpected because grass fiber, and in particular bamboo fiber, has not previously been used in this type of compact laminate.

Optionally, a protective overlay is provided for obtaining particular characteristics not imparted by the laminating resin. By example and without limitation, the novel compact laminate disclosed herein further includes a protective layer of type that affords UV protection from fading and sun damage or another desirable environmental protection not afforded by the laminating resin.

The novel saturation grade paper made of the grass fiber or grass fiber/wood fiber blend is impregnated with resin. The most common types of laminating resin for use in producing the novel compact laminate are phenolic, epoxy, melamine and polyester. Epoxy may be the most durable resin. Other laminating resins that may be useful in practicing the novel compact laminate disclosed herein include but are not limited to amino, silicone, and diallyl phthalate resins to name a few. A thermosetting resin, either of melamine, phenolic or another thermosetting resin, such as urea, is optionally utilized. As discussed in the prior art, the industrially preferred laminating resin for decorative laminates is a phenolic resin made from the reaction of phenols with formaldehyde. The thermosetting resin composition may optionally be any of a phenol/formaldehyde resin, a melamine/formaldehyde resin, a urea/formaldehyde resin or mixtures thereof, as disclosed in U.S. Pat. No. 6,773,799, which is incorporated herein by reference. Alternatively, the laminating resin may optionally be a composition of one of the thermosetting resins with an elastomer and optionally incorporating an alkylene polyamine into the resin-elastomer mixture, as disclosed for example in U.S. Pat. No. 4,109,043, which is incorporated herein by reference.

Another laminating resin that may be useful in practicing the novel compact laminate disclosed herein is an acrylic resin-melamine/formaldehyde resin composition, as disclosed for example by Power, et al. in U.S. Pat. No. 3,983,307, “Thin, Tough, Stable Laminate” issued Sep. 28, 1976, which is incorporated herein by reference.

Optionally, a resin system or “syrup” of water-alcohol solution of phenol/formaldehyde with solvents may be utilized. Still another laminating resin that may be useful in practicing the novel compact laminate disclosed herein is 100 percent water-based melamine/formaldehyde resin system. Else, an aqueous melamine/formaldehyde resin solution with other additives may be utilized.

The laminating resin syrups useful herein are well known to those skilled in the art.

The novel saturation grade paper made of the grass fiber or grass fiber/wood fiber blend is impregnated with the curable laminating resin composition by any conventional method, e.g., dip-, brush-, flow-, roller- or spray-coating. Although the longer grass fiber unexpectedly results in increased resin saturation into the product core over the shorter traditional tree fiber, special impregnating techniques are not required over conventional impregnating methods used with the shorter traditional tree fiber.

The desired degree of impregnation can be achieved by one or several treating passes. As can be readily appreciated, where several treating passes are made, the solids content of the impregnating solution can be low; while for one-pass operations, the solids content will be higher.

Following impregnation, the grass or grass blend sheet is dried or cured as it is commonly referred to, to drive off volatiles before the entire laminating assembly is consolidated in a laminating press. Drying is accomplished at a temperature high enough so that substantially all of the inert organic solvent will be driven off, and yet low enough so that the curable resinous impregnant will not be so substantially advanced in cure that it will not exhibit satisfactory flow under the relatively high pressures encountered in the subsequent laminating step. The curable resinous impregnant thus will flow sufficiently to eliminate small pits, dents and other minor imperfections in the resinous layer.

However, a certain amount of advancement is desirable prior to the time at which the entire laminating assembly is consolidated in a laminating press, inasmuch as this insures that the curable resinous composition will not be squeezed out of the sheet in the press before being substantially completely cured to a solid or “C” stage. Furthermore, since cross-linking takes place fairly rapidly at temperatures above about 100 degrees C., it is evident that any desired degree of advancement can be accomplished either during the drying step, if drying is carried out at sufficiently elevated temperatures, or by an additional heating period at temperatures substantially above room temperature, if drying is carried out at relatively lower temperatures, e.g., room temperature.

The laminating resin is cured in the drying process to a volatile level appropriate to the pressing conditions present in the practice of the invention. The volatile level appropriate for use in a low pressure process is different from that for use in a high pressure process. Furthermore, utilizing only a hot press as opposed to a hot/cold press adds another variable to the process: the appropriate volatile level for a process utilizing a hot/cold press is different from that for a process utilizing only a hot press.

Accordingly, the drying process is selected as a function of pressing conditions such that the laminating resin is dried or cured to a “B” stage as it is commonly referred to, which advances the resin to about a half cured state.

The resultant sheets, i.e., the impregnated grass or grass blend sheet or a plurality of the impregnated sheets are then assembled, in superimposed relationship, each with its coated side on top and facing the adjacent sheet next above. The resultant assembly is then heat and pressure consolidated in conjunction with many more of such assemblies in a manner known in the art to produce the desired laminates.

The assemblies are then pressed in a manner typical of either a conventional high pressure compact laminate or a low pressure laminate. For example, in a high pressure process the assemblies are placed between cold rolled steel plates and inserted in a conventional high pressure hydraulic press and heated to about 275 to 300 degree F. and about 1,000 psi to 1,200 psi and up to about 1,400 psi for a predetermined period, for example, about 15 minutes, to cure the laminating resin. Practice of the present novel compact laminate optionally utilizes a slow curing melamine or other laminating resin that cures more slowly than a traditional melamine resin. Use of slower curing resins permits the center layers to reach cure temperature when multiple layers of the impregnated grass or grass blend sheets are used to make a thicker panel, which in turn ensures complete curing of the impregnant of the centermost sheets. This use of slow curing resin is in contrast to the fast curing melamine resins used in conventional prior art processes where a single layer of the melamine impregnated paper is assembled as the decorative surface layer over a core of numerous layers of kraft paper impregnated with phenolic resins. Thus, according to the present novel compact laminate, the multiple layers of resin impregnated sheets are consolidated under heat and pressure into an extremely strong, solid, homogenous laminated monolithic mass.

When the present novel compact laminate is practiced in a low pressure process, the pressure may be in the range of about 200 psi or less to as much as about 300 psi or more. The low pressure process may also use more use more resin than the high pressure process to ensure sufficient resin flow within the sheets to consolidate the sheets into the extremely strong, solid, homogenous laminated monolithic mass. In general, resin usage is minimized; however, lower pressures require more resin to ensure sufficient flow within the sheets.

The fully cured laminated assembly is optionally cooled while still under pressure to ensure that the panels resist warp while cooling and remain flat. For example, when the press is a type having a cooling cycle, the assembly is optionally cooled down to about 100 degrees F. while still under pressure in the press. Otherwise, the assembly is optionally removed hot from the press and stacked on a cooling slab under sufficient load to hold the panels flat while they cool. Fans may be utilized to accelerate the cooling process.

After cooling, the resultant laminates are separated, trimmed and packaged. Thinner sections of the novel laminates disclosed herein having only one or a few sheets of the resin impregnated grass or grass blend paper are optionally utilized similarly to the thin decorative surface layers of the prior art and bonded to thicker self-supporting substrates or core layers to form self-supporting panels. Else, thicker sections having multiple layers of the resin impregnated grass or grass blend paper are self-supporting and are optionally utilized as stand alone panels replacing the traditional compact laminates of the prior art.

The novel compact laminates disclosed herein have a compressive strength of 50,000 psi and can be cut, routed, sanded and finished with typical woodworking tools, much like butcher block style surfaces for either creating a new panel, or repairing an existing one.

### Powder Coated Resin Laminate Materials and Methods for Producing Same

Curable coating powders are known for use in coating glass, ceramics, and graphite-filled composites, as well as metallic substrates such as steel and aluminum. Some curable coating powder compositions are particularly useful in the coating of heat sensitive substrates such as plastics, paper, cardboard, and wood, where wood is defined as lignocellulosic materials from trees whether in its natural form, shaped in a saw mill, separated into sheets and made into plywood, or chipped and made into particleboard, or made into medium density fiberboard (MDF), and the like. One such substrate commonly coated with curable coating powder compositions is engineered wood.

As used herein, a coating powder means a solid, particulate, film-forming composition, whereas a powder coating means the film formed on a substrate by curing a coating powder. Coating powders are usually formed of a solid, thermoplastic or thermosetting film-forming polymer resin. A number of different types of thermoplastic resins for coating powders are known, such as vinyl chloride, polyamides, celluloses, polyolefins, polyethylene, and polyesters to name some examples. Thermosetting film-forming resins contain reactive functional groups, an optional curing agent, i.e., a crosslinking agent, having functional groups reactive with the functional groups of the polymer resin, and which may itself be another film-forming polymer, and an optional catalyst. Known thermosetting resins include but are not limited to acid-functional polyester resins, acid-functional acrylic resins, epoxy resins, and hydroxyl-functional polyester resins.

In U.S. Pat. No. 7,122,585, which is incorporated herein by reference, Nicholl, et al. discloses examples of suitable coating powder compositions capable of cure at such low temperatures, methods of manufacture thereof, and articles formed therefrom. Such coating powder compositions of the type disclosed by Nicholl, et al. and method of manufacture and application are entirely suited to coating consolidated laminated panel disclosed herein.

Useful polymer resins are generally low cure-temperature thermosetting resins that are suitable for use with heat-sensitive substrates such as wood, MDF, and some plastics. Low cure temperature compositions generally cure at temperatures less than 325 degree F. (163 degree C.) and may cure at less than 275 degree F. (135 degree C.). Cure is also generally greater than about 100 degree F. (39 degree C.), but may be greater than 200 degree F. (93 degree C.) which provides stability both during processing and in storage. U.S. Pat. No. 6,294,610 to Daly, et al., which is incorporated herein by reference, discloses one example of a suitable coating powder composition capable of cure at such low temperatures. The low cure temperature composition of Daly, et al. is an acid functional polymer, such as a carboxylic acid functional polyester or a carboxylic acid functional acrylic resin, a polyepoxy compound, and an optional catalyst. Such low cure temperature coating powder compositions of the type disclosed by Daly, et al. and method of manufacture and application are entirely suited to coating consolidated laminated panel disclosed herein.

Other preferred polyepoxy compounds, especially for low temperature cure compositions, are epoxy-functional acrylic or methacrylic resins such as glycidyl acrylate or glycidyl methacrylate copolymer (collectively, “GMA”) resins. GMA resins are typically obtained from 5 to 30 wt % of glycidyl acrylate or glycidyl methacrylate and 80 to 95 wt % of methyl methacrylate. Suitable GMA resins are solid at room temperature, having melting points above about 100 degree F. (40 degree C.), a softening point of about 120 to about 165 degree F. (50 to 75 degree C.), and a glass transition temperature (Tg) of about 100 to about 140 degree F. (40 to 60 degree C.). GMA resin may also be combined with a matte texturizing agent, such as polytetrafluoroethylene (PTFE), or mixtures of PTFE and low melting waxes such as paraffin, to form a suitable coating powder composition.

Although the resins are self-curing, a catalyst is optionally added to accelerate the curing rate to a commercially desirable value. When present, the curing agent may be used in an amount of anywhere from about 0.1 to about 30 parts by weight per 100 parts by weight of the combined acid functional polymer and polyepoxy compound. Several suitable catalysts are known.

Another example of a suitable coating powder composition capable of cure at low temperatures is an epoxy thermosetting resin, hereinafter referred to as an epoxy resin, and may include an optional catalyst. The Tg of a suitable epoxy resin is preferably high enough that the particles do not fuse together or sinter at temperatures that are likely to be encountered during transportation and storage. For example, the Tg is preferably at least 120 degree F. (50 degree C.), more preferably at least about 140 degree F. (60 degree C.). Useful epoxy resins are available from a wide variety of commercial sources. Catalysts are also useful to accelerate the cure of the epoxy resin. Mixtures of curing agents also may be used.

Still another example of a suitable coating powder composition capable of cure at low temperatures is a hydroxy-functional polyester resin used with a blocked isocyanate-functional curing agent. The blocked isocyanate may be internally blocked, such as the uret dione type, or may be of the caprolactam-blocked type, for example isophorone diisocyanate. Hydroxy-functional polyester resins may also be used with an amine-formaldehyde condensate such as, for example, a melamine resin, a urea-formaldehyde resin, a glycol ural formaldehyde resin, or hexahydromethyl melamine.

Mixtures of particulate film-forming polymeric resins may also be used. For example, a carboxy-functional polyester may be used with a carboxy-functional acrylic resin and a curing agent such as bis(beta-hydroxyalkylamide), which serves to cure both polymers. Alternatively, a carboxy-, hydroxy-, or epoxy-functionalized acrylic resin may be used with an epoxy resin or carboxy- or hydroxyl-functional polyester resin, selected so as to be co-curing, cured with a single curing agent, or cured with more than one curing agent.

Known coating powders are usually dry, finely divided, free-flowing solid materials at room temperature. They are conveniently applied using electrostatic methods. In electrostatic powder coating, an electric potential is generated between the coating powder and the substrate to be coated. The electric potential causes the powder particles to be attracted to the substrate. Charging of the powder may be effected by an applied voltage or by friction, commonly referred to as “tribocharging.” U.S. Pat. No. 5,585,426, Williams, et al., which is incorporated herein by reference, discloses another process for improving the electrostatic charge developed on a coating powder composition for electrostatic coating. An electrostatic property-modifying agent is incorporated into the resin, is charged by electrical induction/conduction, and then the charged coating powder composition sprayed onto a grounded solid substrate. Once the coating powder composition is sprayed, the charge facilitates the adherence of the coating powder to the substrate and enables thermal fusing of the coating powder to produce a permanent finish.

Irrespective of their particular compositions, the coating powder compositions include a conductive additive that improves coverage of the substrate. Conductive additives are particularly useful with less conductive or dielectric substrates. Several different types of conductive additives are known to be used with coating powder compositions, including conductive carbon, particles coated with a conductive layer, conductive metallic fillers, and conductive quaternary amine divinylbenzene/styrene copolymers.

Various types of conductive carbon fibers are known in the art, and include, for example, carbon fibers, carbon nanofibers, carbon nanotubes, carbon black, or combinations including at least one of the foregoing.

In addition to conductive carbon, particles coated with a conductive layer can be used. The coated particles themselves may be conductive, e.g., copper powders or flakes coated with silver, or nonconductive, e.g., hollow or solid glass spheres coated with silver, glass fibers coated with silver, or aluminum spheres coated with silver.

Conductive metallic and non-metallic fillers may also be used, including conductive metals or alloys that do not melt under conditions used to incorporate them into the coating powder. Metals such as aluminum, copper, magnesium, chromium, tin, nickel, silver, iron, titanium, and mixtures having any one of the foregoing metals can be incorporated into the resins as solid metal particles. Physical mixtures and true alloys such as stainless steels, bronzes, and the like, can also serve as metallic constituents of the conductive filler particles. In addition, certain intermetallic chemical compounds such as borides, carbides, and the like, of these metals, e.g., titanium diboride, can also serve as conductive constituents of the conductive filler particles. Solid non-metallic, conductive filler particles such as tin oxide, indium tin oxide, and the like may also be used. One suitable filler of this type is a commercially known conductive titanium dioxide coated with tin oxide and antimony pentoxide.

The conductive filler is optionally a conductive polymer, for example, a commercially available quaternary amine divinylbenzene/styrene copolymer. Another type of conductive polymer is a polypyrrole.

The conductive filler may exist in the form of drawn wires, tubes, nanotubes, flakes, laminates, platelets, ellipsoids, spheres, discs, irregular, and other commercially available geometries. The size and amount of the conductive filler present in the coating powder composition is a function of other considerations such as the composition of the conductive filler, the cost of the conductive filler, the coating powder composition, filler amount, ease of incorporation into the coating powder composition, conductivity of the substrate, and the like. In general, use of small particles less than about 20 microns, or about 50 to 150 microns, results in coating powder compositions that form even, conformal powder coatings. Typically, the conductive filler is included in small amounts that provide enhanced conductivity, without significantly interfering with coating properties such as melt temperature, durability, hardness, appearance, and the like.

Regardless of the size, shape, and composition, the conductive filler particles are thoroughly and uniformly dispersed throughout the coating powder composition. The conductive filler particles may be pre-dispersed in a resin in order to facilitate incorporation into the coating powder composition.

Use of the described conductive fillers in coating powder compositions imparts enhanced conductivity to the composition, thereby leading to improved deposition by electrostatic or other methods.

The coating powder composition also may optionally include one or more additional additives known in the art. Such additives include, for example, flow control agents, dry flow agents, antioxidants, pigments, optical brighteners, extenders, combinations of at least one of the foregoing additives, and the like. Flow control agents, sometimes called leveling agents, are useful to promote the formation of a continuous coating. Pigments may be used to adjust color and opacity.

The coating powder with its conductive additive may be applied to substrates by conventional means, including electrostatic fluidized beds, electrostatic spray guns, triboelectric guns, and the like, in which the powder coating particles are electrostatically charged and the substrate is grounded or oppositely charged. In electrostatic powder coating, application is usually directly to a surface of the substrate, so that use of primers or other undercoats is not required. The substrate is optionally preheated prior to application. During application the substrate is heated which aids melting, flow, and coalescence of the particles. Coating powders are generally applied to achieve a coating thickness of 1.0 mil (0.0245 millimeters, “mm”) to about 25 mils (0.102 mm), and may be applied to achieve a coating thickness of at least 4 to 10 mils (0.1 to 0.25 mm).

Electrostatic powder coating has most often been used for metal substrates that are natural conductors of electricity. Substrates that are non-conductive or dielectric must be treated to make them permanently, or at least temporarily, electrically conductive. For materials such as wood, electrically charged primers have been developed. For example, U.S. Pat. No. 4,686,108 to Nason, et al., which is incorporated herein by reference, discloses applying a non-aqueous, surfactant-free primer formed of a conductive polymeric material to a wooden substrate, drying the coating, then applying a coating powder.

Substrates being electrically coated with curable coating powder compositions may have a moisture content in the range of about 3 to 10% by weight. The substrate may be treated to enhance its electrical conductivity. Thus, a porous substrate such as particleboard, when suitably pre-coated with a conductive liquid coating composition and cured, may be used as a substrate for the electrostatic coating powder. Although not necessary, the wood substrate may be heated to drive excess moisture out that otherwise may cause surface defects in the coating.

Alternatively, the coating compositions are optionally applied to substrates by any conventional method, such as spraying, rolling, dipping, and the like.

After application to the substrate, the applied powder coating is cured, generally at a temperature of 200 to 500 degree F. (93 to 260 degree C.), but may be in the temperature range of about 250 to 400 degree F. (121 to 204 degree C.). Low curing temperatures of wood substrates is generally less than 325 degree F. (163 degree C.), but may be less than 250 degree F. (121 degree C.). Another advantage of the curable compositions is their ability to produce matte and low gloss finishes over a wide range of curing temperatures. For example, such finishes may be produced over the entire temperature range of 250 degree F. to 400 degree F.

Such powder coating compositions of the type disclosed herein above and methods of application are entirely suited to coating consolidated laminated panel disclosed herein.

In U.S. Pat. No. 6,077,608, which is incorporated herein by reference, Barkac, et al., discloses an alternative cured thermoset multilayered composite coating with a powder clear coat and a waterborne base coat having improved chip resistance. The cured, thermoset multilayered composite coating is intended for substrates such as metallic and plastic substrates, but can be applied to various substrates, including wood, glass, and plastic. A thermosetting powder coating composition provides a clear coat which is cured at least to some degree along with the base coat to form a thermoset multilayered composite coating. This composite coating has improved chip resistance over prior art coatings. The multilayered composite coating on the substrate usually has a cured primer coating layer beneath the base coat layer when used for automotive applications. The method of forming the cured thermoset base coat and clear coat composite coating assists in improving chip resistance. Two thermosetting curable powder coatings are disclosed in U.S. Pat. Nos. 5,270,391 and 5,407,706, which are incorporated herein by reference. These thermosetting curable powder coating compositions have epoxy functional acrylic copolymers in blends of either: a high softening point acrylic with another low softening point acrylic, or different viscosities for acrylic polymers.

The powder clear coat for the multilayered composite coating of Barkac, et al. has a mobile crosslinkable film-forming polymer along with a crosslinking agent, where the term “film forming” means 1) the particulate polymeric material of a powder coating upon melting and curing at elevated temperature, or 2) the polymeric material dispersed or solubilized in a solvent or carrier upon drying or evaporation of the solvent or carrier and curing of the polymeric material forms a self-supporting continuous film on at least a horizontal surface. Examples of such mobile film-forming polymers include solid particulate acrylic polymers and copolymers with crosslinkable groups like epoxy or glycidyl. Generally, the other acrylic polymers and copolymers can be used as long as their molecular weight (Mn or Mw) is in a range similar to the range for the epoxy acrylic polymer. These acrylic polymers and copolymers can have other functional groups with abstractable hydrogen such as hydroxyl, carboxyl, and amino and suitable noninterfering mixtures thereof.

The epoxy acrylic polymer can be prepared by copolymerizing a glycidyl functional ethylenically unsaturated monomer with an ethylenically unsaturated monomer or mixture of monomers free of glycidyl functionality. The glycidyl functional monomer can be copolymerized with one or more monomers having a Tg greater than 200 degree F. (93 degree C.). A high Tg monomer can assist in preventing caking and instability problems associated with powder coatings.

The epoxy acrylic polymer can be prepared by traditional free radical initiated polymerization techniques using suitable catalysts and chain transfer agents. The preparation of the epoxy copolymer as an epoxy-containing acrylic polymer may be conducted as disclosed in U.S. Pat. No. 4,650,718, which is incorporated herein by reference.

The powder coating composition is prepared by combining approximately 60 to 90 percent by weight of the epoxy copolymer with about 10 to 40 percent by weight, based on total weight of the powder coating of a suitable crosslinking agent. When the epoxy copolymer is in the lower portion of the aforementioned range, minor amounts of other film-forming polymers known to those skilled in the art to be useful in powder coating can be used.

The thermosetting powder coating composition may also contain additional materials as known to those skilled in the art. For example, an anhydride additive improves cure response and copolymer of an alpha olefin and olefinically unsaturated anhydride improves humidity resistance of the cured coating. Additionally, polymer or copolymer flow control or flow modifying agents known to those skilled in the art can be used effectively in the powder coating composition.

The thermosetting powder coating compositions can optionally include other materials such as pigments, fillers, light stabilizers and antioxidants such as those shown in U.S. Pat. No. 5,407,707, which is incorporated herein by reference. Anti-popping agents can be added to the composition to allow any volatile material to escape from the film during baking. In addition, the thermosetting powder coating composition may include fumed silica or the like to reduce caking of the powder during storage.

The thermosetting powder coating compositions are prepared by melt blending the ingredients and pulverizing the mixture into a particulate blend. The resulting particulate mixture can be applied by conventional spraying techniques. The thermosetting powder coating compositions can be applied as clearcoats in color-plus-clear or basecoat, clearcoat composite coatings.

The waterborne base coat of the multilayered composite coating having the powder clear coat has a film-forming composition that can be the film-forming polymers and copolymers such as acrylic polymers, polyesters, including alkyds, and polyurethanes and blends and mixtures thereof The waterborne base coat also has one or more crosslinking agents for the film-forming resin, and optionally one or more pigments to act as the colorant. Suitable curing agents can be added for such film-forming polymers of the base coat. Suitable waterborne base coat compositions are disclosed in U.S. Pat. No. 4,403,003 and European Patent Nos. 0038127, 0206615, 0502934, 0260447, 0281936, 0228003 and 0355433, which are incorporated herein by reference, and the resinous compositions used in preparing these base coats can be used in the practice of this invention. Also, waterborne polyurethanes such as those prepared in accordance with U.S. Pat. No. 4,147,679, which is incorporated herein by reference, can be used as the resinous binder in the base coat. Further, waterborne coatings such as those described in U.S. Pat. No. 5,071,904, which is incorporated herein by reference, can be used as the base coat.

The base coat may also contain pigments to give it color. The base coating compositions may contain metallic pigments or non-metallic color pigments of the type conventionally used in surface coatings, including inorganic and organic pigments. Usually, the film-forming composition will also preferably contain catalysts to accelerate the cure of the crosslinkable film former and crosslinking agent like aminoplasts.

Optionally, the base coat composition also may contain additional materials well known in the art of formulated surface coatings, including surfactants, flow control agents, thixotropic agents, fillers, anti-gassing agents, organic cosolvents, catalysts, and other customary auxiliaries.

The base coating compositions can be applied to various substrates to which they adhere including wood, metals, glass, and plastic. The compositions can be applied by conventional means including brushing, dipping, flow coating, spraying and the like. The usual spray techniques and equipment for air spraying and electrostatic spraying and either manual or automatic methods can be used. During application of the base coat composition to the substrate, a film of the base coat is formed on the substrate. The base coat film is of suitable thickness.

After application of the base coat to the substrate, a film is formed on the surface of the substrate by driving solvent, i.e., organic solvent or water, out of the base coat film by heating or by an air drying period. Preferably, the heating is accomplished at low temperature and only for a short period of time, sufficient to ensure that the clear coat can be applied to the base coat without the former dissolving the base coat composition, yet insufficient to fully cure the basecoat. Suitable drying conditions are a function of the particular waterborne base coat composition, and on the ambient humidity with certain waterborne compositions. At the same time, the base coat film is adequately wetted by the clear coat composition so that satisfactory intercoat adhesion is obtained. Also, more than one base coat and multiple clear coats may be applied to develop the optimum appearance. Usually between coats, the previously applied coat is flashed; that is, exposed to ambient conditions for a short period.

Application of the powder coating of Barkac, et al. can be by spraying, by electrostatic spraying, or by the use of a fluidized bed. The powder coating can be applied in a single sweep or in several passes to provide a film having a desired thickness after cure. After application of the coating composition such as the preferred powder coating, the powder coating substrate is baked at a low temperature sufficient to cure the coating, typically at about 250 to about 400 degree F. (121 to 204 degree C.) for about 10 to 30 minutes or as long as about 60 minutes.

Such powder coating compositions of the type disclosed by Barkac, et al. and such methods of application are entirely suited to coating consolidated laminated panel disclosed herein.

In U.S. Pat. No. 6,124,401, which is incorporated herein by reference, Hart, Jr., et al. discloses a thermoplastic coating compositions and process using same. This coating composition includes: (A) at least one polymeric material selected from (i) at least one homopolymer of ethylene, or (ii) at least one copolymer of ethylene and a second ethylenically unsaturated monomer, or (iii) at least one thermoplastic acrylic homopolymer or copolymer having a glass transition temperature (Tg) of greater than about 32 degree F. but less than 230 degree F. (0 to 110 degree C.), or (iv) a mixture of (i), (ii) and/or (iii); and (B) at least one thermoplastic polymeric material different than (A) having a melting point in the range of about 175 degree F. to about 265 degree F. (80 to 130 degree C.) and being miscible with (A), and wherein the viscosity of the polymer composition (A) and (B) is in the range of about 5,000 cps to about 100,000 cps at a temperature range of about 200 to about 300 degree F. (93 to 149 degree C.). Hart, Jr., et al. further provides for a process for applying the foregoing thermoplastic coating composition to a substrate such as glass, ceramic, metal, fiberboard, textile or plastic substrate. The thermoplastic coating composition is applied using hot melt screen printing. The process also employs a low-temperature cure that requires only a relatively brief cure time, e.g., less than about one second. The thermoplastic coating composition can be reheated to obtain higher gloss and/or enhance the adhesion of the coating to the substrate.

Such a thermoplastic coating composition of the type disclosed by Hart, Jr., et al. and method of application are entirely suited to coating consolidated laminated panel disclosed herein.

In U.S. Pat. No. 6,296,939, which is incorporated herein by reference, Kunze, et al. discloses a heat-sensitive substrate coated with powder paint wherein a layered material consisting of a substrate of heat-sensitive material, such as wood, has a powder paint coat applied thereon. Heat-sensitive materials that can be used as substrates for the coating include solid woods, and hard-fiber and medium-density panels (MDF). Suitable powder paints contain epoxy resins, carboxypolyesters, catalysts, secondary substances and, if necessary, secondary agents, and additives typically associated with powders, and agents to enhance their frangibility. The powder paint coat is characterized in that it is obtained by a) optional application of an extender coat, b) optional application of at least one (water-based) paint, c) heating of the substrate by microwave irradiation, d) optional hardening of the liquid paint, preferably by ultraviolet irradiation, e) application of the powder paint, preferably by electrostatic spraying or by the Tribo process, f) heating of the powder paint to sintering temperature, g) subsequent hardening of the paint coat. Several suitable epoxy resins are commercially available. Such a powder paint coat and method of application of the type disclosed by Kunze, et al. are entirely suited to coating consolidated laminated panel disclosed herein.

Polyacrylate resins that contains epoxy groups are suitable as acid functional bonding agent. The polyacrylate resin that contains epoxy groups can be manufactured by radical polymerization, using generally well known methods. Acid functional agents optionally serve as hardeners for the epoxy functional acrylates described above. Phenolic hardeners are also suitable for hardening the epoxy functional bonding agent.

The powder paints according to the present invention contain one or more suitable catalysts for hardening the epoxy resin.

The powder paints optionally contain 10 to 40% by weight of glycidyl-group functionalized crystalline silicic acid modifications relative to the total weight of the powder paints. The powder paints can also contain additional inorganic extenders and pigments. In addition, the powder paints can also contain secondary agents and additives, such as flow agents, degassing agents, and agents that enhance frangibility.

In addition to the powder paints described above, it is also possible to use powders that can be hardened by irradiation, such as ultraviolet light or electron irradiation. Powders such as these are described, for example, in EP application 0585742, which is incorporated herein by reference.

Powder paints are manufactured using known methods, for example, by homogenization and dispersion, by using an extruder, a screw-type kneading machine, or the like. Once they have been manufactured, the powder paints are adjusted to the desired grain-size distribution by screening and sieving.

Prior to being coated with the powder paints described above, the substrate is pre-heated, for example, by means of microwave irradiation which achieves an optimal coating using powder paints.

When applying coatings on the materials discussed herein, particular attention must be paid to the effect of the moisture content in the wood.

When wood and wood products are electrostatically coated with powder paint, the moisture content of the wood determines the electrical conductivity of the material. During application of the heat that is required to melt and harden the powder paint coat, moisture and other volatile components of the wood are given off as gas, depending on the temperature of the work piece and the duration of the heating. As the removal of moisture or the escape of gas becomes more pronounced, the danger of bubbles forming in the coating film will increase. Pores and bubbles in the coating lead to the more or less pronounced degradation of quality. However, as moisture is given off during the heating process, wood work pieces may undergo coloration, deformation, and crack due to shrinkage. Subsequent absorption of moisture will cause swelling and thus the build-up of internal stresses in the boundary layer between the carrier material and the coating, and this may cause damage to the workpiece.

Processing using microwave irradiation does not cause the surface of the wood to dry out. At the same time, the wood is degassed so that volatile substances, in particular moisture as well as terpene hydrocarbons can escape from the coniferin wood, out of the upper layers of the wood based substance, even before it is coated or during the heating phase, i.e., the smelt phase of the powder, so that the subsequent reaction phase is not disrupted. This degassing of volatile substances prevents the formation of bubbles in the paint coat.

The surface of the wood is heated to about 175 to 250 degree F. (80 to 120 degree C.) by microwave irradiation. Subsequently, the powder paint is applied to the surface of the substrate by electrostatic spraying, but optionally by using the Tribo process.

A minimum surface resistance is needed to ensure even build-up of the coat of powder paint on the surface of wood work pieces, which minimum surface resistance is achieved by pre-heating by microwave irradiation.

After application, the powder paint is sintered at temperatures of about 212 to 340 degree F. (100 to 170 degree C.). Electromagnetic radiation is not suitable for sintering the powder paint on wood based products. As a rule, the powder paint is heated either by forced-air or by infrared irradiation. When the powder paint is hardened by radiation, heat is required only for the sintering process. Other paints that are hardened by ultraviolet radiation have the hardening reaction started directly after the sintering process, since the reduction of temperature affects the reactivity of the powder. For this reason, the hardening reaction is carried out at temperatures between about 175 and 320 degree F. (80 and 160 degree C.).

In the case of wood substrates that have large pores, and wood based composite materials, such as plywood, it is important is that the coating remains permeable to water vapor in the temperature range from 140 to 250 degree F. (60 to 120 degree C.) in order to prevent accumulation of water vapor in the wood or wood based material beneath the coating.

Such a powder paint coat and method of application is entirely suited to coating consolidated laminated panel disclosed herein.

As discussed herein above, known compact laminates produced by both low pressure and high pressure resin methods are generally well-known as extremely strong, solid, homogenous panel components with superior wear-resistance, but are also well known as being suitable for internal use only since the laminating resin generally lacks UV protection against fading and sun damage and other desirable environmental protections.

As also discussed herein above, some curable coating powder compositions are particularly useful in the coating of heat sensitive substrates such as plastics, paper, cardboard, and wood, including natural wood and engineered wood, plywood, particleboard, medium density fiberboard (MDF), and the like. However, application of curable coating powder compositions to compact laminates is not known in the prior art.

The inventor hereof determined the applicability of curable coating powder compositions to compact laminates. As disclosed herein, application of a curable coating powder composition to a compact laminate creates thereon a protective layer of type that permits use as an exterior building or construction product that enjoys UV protection from fading and sun damage as well as other desirable environmental protections not afforded by the laminating resin. Accordingly, the present invention provides a novel powder coated consolidated laminated article in panel form.

When applied to a consolidated laminated article of the type disclosed herein, a film of a substantially completely cured solid powder coating composition is laminated to at least a portion of an outer surface of the consolidated laminated article. Suitable coating powders are formed of a solid, thermoplastic or thermosetting film-forming polymer resin. A film of the coating powders forms a solid, thermoplastic or thermoset film of polymer resin on a surface of the consolidated laminated article. Accordingly, a powder coated consolidated laminated article is formed by, applying to a thermal set resin compact laminate substrate a solid powder coating composition of a type that is substantially completely curable at temperatures greater than about 100 degree F. to about 200 degree F. (39 to 93 degree C.), which provides stability both during processing and in storage, and an elevated temperature less than about 500 degree F. According to one embodiment, the solid powder coating composition of a type that is substantially completely curable at temperatures in a range of about 250 to 400 degree F. (121 to 204 degree C.). However, some consolidated laminated article of the type disclosed herein may qualify as heat sensitive substrates. Therefore, the solid powder coating composition is optionally of a type that is substantially completely curable at low curing temperatures less than 325 degree F. (163 degree C.) and may be substantially completely curable at less than 275 degree F. (135 degree C.).

As discussed herein above, thermosetting film-forming resins contain reactive functional groups, an optional curing agent, i.e., a crosslinking agent, and an optional catalyst.

Low cure-temperature thermosetting resins are known to be suitable for use with heat-sensitive substrates such as wood, MDF, and some plastics. The inventor determined that such low cure-temperature thermosetting resins are also suitable for powder coating consolidated laminated articles of the type disclosed herein. Low cure temperature compositions of powder coatings suitable for consolidated laminated articles include, by example and without limitation, an acid functional polymer, such as a carboxylic acid functional polyester or a carboxylic acid functional acrylic resin, a polyepoxy compound, and an optional catalyst. GMA resins are also suitable when they are solid at room temperature, have melting points above about 100 degree F. (40 degree C.), a softening point of about 120 to about 165 degree F. (50 to 75 degree C.), and a glass transition temperature (Tg) of about 100 to about 140 degree F. (40 to 60 degree C.). A catalyst is optionally added to accelerate the curing rate of the crosslinkable film former and crosslinking agent like aminoplasts. Still other examples of coating powder compositions capable of cure at low temperatures suitable for powder coating consolidated laminated articles of the type disclosed herein are disclosed herein and are also contemplated and may be substituted without deviating from the scope and intent of the present invention. Mixtures of particulate film-forming polymeric resins may also be substituted without deviating from the scope and intent of the present invention.

Optionally, one or more additional constituents are incorporated into the powder coating composition before application to the compact laminate substrates. For example, the one or more additional constituents include surfactants, polymer or copolymer flow control or flow modifying agents, dry flow agents, antioxidants, pigment such as metallic pigments or non-metallic color pigments of the type conventionally used in surface coatings, including inorganic and organic pigments, matte texturizing agents, light stabilizers, optical brighteners, extenders, an anhydride additive, anti-popping agents, thixotropic agents, fillers, anti-gassing agents, organic cosolvents, catalysts, and other customary auxiliaries.

The powder coating compositions disclosed herein are optionally applied to the compact laminate substrates disclosed herein by any conventional method, such as spraying, rolling, dipping, and the like.

Alternatively, applying the film of a solid powder coating composition to the compact laminate substrates is optionally accomplished by electrostatically applying the film of a solid powder coating composition. Preparing the powder coating composition optionally includes incorporating an electrostatic property-modifying agent into the coating composition, the electrostatic property-modifying agent being thoroughly and uniformly dispersed throughout the coating powder composition. The electrostatic property-modifying agent is, for example, a conductive metallic or non-metallic filler, or certain intermetallic chemical compounds of certain metals, or the conductive filler is optionally a conductive polymer. The conductive filler particles may be pre-dispersed in a resin in order to facilitate incorporation into the coating powder composition. The conductive fillers in the coating powder compositions imparts enhanced conductivity to the composition, which improves deposition by electrostatic as well as other methods.

Applying the powder coating composition to the compact laminate substrates is accomplished as disclosed herein by generating an electric potential between the coating composition and the substrate, and electrostatically attracting the coating composition to the substrate. The coating powder with its conductive additive may be applied to substrates by conventional means, including electrostatic fluidized beds, electrostatic spray guns, triboelectric guns, and the like, in which the powder coating particles are electrostatically charged and the substrate is grounded or oppositely charged. Optionally, the compact laminate substrates are treated to make them permanently, or at least temporarily, electrically conductive. For example, prior to electrostatically applying the film of powder coating composition an electrically charged primer is optionally earlier applied to at least the portion of an outer surface of the compact laminate substrates that is to be powder coated.

During application of the coating powder the compact laminate substrate is heated which aids melting, flow, and coalescence of the particles of coating powder. Optionally, the compact laminate substrate is additionally pre-heated prior to application of the coating powder.

When the powder coating composition is applied to the compact laminate substrates disclosed herein, the compact laminate substrates are optionally cooled as disclosed herein prior to application of the powder coating composition. Alternatively, the powder coating composition is applied during manufacture of the compact laminate substrates. Accordingly, the paper sheets are impregnated with the curable laminating resin composition. The curable laminating resin composition is partially dried or cured to its “B” stage, which advances the resin to about a half cured state. A plurality of impregnated paper sheets are then assembled, in superimposed relationship, each with its coated side on top and facing the adjacent sheet next above. The resultant assembly is then heat and pressure consolidated in conjunction with many more of such assemblies in a manner known in the art to a substantially completely cured solid or “C” stage to produce the desired laminates. According to one embodiment, the assembled plurality of impregnated paper sheets includes one or more of the impregnated grass or grass blend sheet sheets as disclosed herein. For example, the grass or grass blend sheet sheets are formed of a grass fiber, such as a bamboo fiber as disclosed herein, instead of the conventional wood fibers from trees.

The consolidated laminate substrates are optionally cooled to about 100 degrees F. in a cooling cycle of the press is while the product is still under pressure to retard warp while cooling and ensure the resultant panels are flat. The consolidated laminate substrate product is optionally removed hot from the press, and stacked on a cooling slab under heavy load to maintain flatness, while being cooled with fans. Optionally, while the consolidated laminate substrates are still hot, the coating powder is applied to the compact laminate substrate. Application of the coating powder while the consolidated laminate substrates are still hot may be cost effective substitute for pre-heating. The powder coating composition is applied, and the compact laminate substrate is heated to aid melting, flow, and coalescence of the particles of coating powder.

Subsequently, the powder coated consolidated laminated panels are cooled as disclosed herein. Thereafter, the resultant powder coated laminates are separated, trimmed and packaged.

The result of the above is a powder coated consolidated laminated panel formed of a plurality of paper sheets each impregnated with a substantially completely cured resinous composition, assembled in superimposed relationship, and heat and pressure consolidated into a consolidated laminated panel with a film of a substantially completely cured solid powder coating composition laminated to at least a portion of an outer surface of the consolidated laminated panel. The assembled plurality of impregnated paper sheets of the consolidated laminated panel optionally includes one or more of the impregnated grass or grass blend sheet sheets as disclosed herein, such as grass or grass blend sheet sheets formed of a grass fiber, such as a bamboo fiber as disclosed herein, instead of the conventional wood fibers from trees.

The powder coating composition is of a type that is substantially completely curable at temperatures greater than about 100 degree F. to about 200 degree F. (39 to 93 degree C.), and less than an elevated temperature about 500 degree F. However, the solid powder coating composition may be substantially completely curable at temperatures in a range of about 250 to 400 degree F. (121 to 204 degree C.) and may be substantially completely curable at low curing temperatures less than 275 degree F. to 325 degree F. (135 degree C. to 163 degree C.). The powder coating composition may be but is not limited to any one of a thermoplastic powder coating composition, a thermosetting powder coating composition, or an epoxy thermosetting resin powder coating composition, and may include an optional curing agent, i.e., a crosslinking agent, and an optional catalyst.

The solid powder coating composition optionally includes one or more additional constituents, wherein each of the one or more additional constituents is a constituent selected from the group of constituents consisting of surfactants, polymer or copolymer flow control or flow modifying agents, dry flow agents, antioxidants, pigment such as metallic pigments or non-metallic color pigments of the type conventionally used in surface coatings, including inorganic and organic pigments, matte texturizing agents, light stabilizers, optical brighteners, extenders, an anhydride additive, anti-popping agents, thixotropic agents, fillers, anti-gassing agents, organic cosolvents, catalysts, and other customary auxiliaries.

The powder coated consolidated laminated panel optionally includes a film of an electrically charged primer applied to the outer surface of the consolidated laminated substrate, and the solid powder coating composition further includes a conductive additive constituent. The solid powder coating composition is laminated to the film of electrically charged primer, when present.

When the powder coating composition is a thermosetting powder coating composition, the composition is a solid particulate mixture of a) a film-forming resinous binder including i) a copolymer selected from the group consisting of epoxy, polyester and acrylic copolymers, and ii) a crosslinking agent capable of reacting with the copolymer, b) one or more flow control agents, and c) a catalyst.

While the preferred and additional alternative embodiments of the invention have been illustrated and described, it will be appreciated that various changes can be made therein without departing from the spirit and scope of the invention. Therefore, it will be appreciated that various changes can be made therein without departing from the spirit and scope of the invention. Accordingly, the inventor makes the following claims.

What is claimed is:

1. A powder coated consolidated laminated article, comprising:
at least one paper sheet impregnated with a substantially completely cured resinous composition; and
a film of a substantially completely cured solid powder coating composition laminated to at least a portion of an outer surface of the impregnated paper sheet.

2. The article of claim 1, further comprising a film of an electrically charged primer applied to the at least a portion of an outer surface of the impregnated paper sheet; and the substantially completely cured solid powder coating composition laminated to the film of electrically charged primer.

3. The article of claim 2 wherein the solid powder coating composition further comprises an electrostatic property-modifying agent.

4. The article of claim 3 wherein the solid powder coating composition further comprises one of a thermoplastic powder coating composition, and a thermosetting powder coating composition.

5. The article of claim 4 wherein the solid powder coating composition further comprises one or more additional constituents, wherein each of the one or more additional constituents is a constituent selected from the group of constituents consisting of a flow control agent, a dry flow agent, an antioxidant, a pigment, a matte texturizing agent, a light stabilizer, an optical brightener, an extender, an anhydride, an anti-popping agent, an anti-gassing agent, a thixotropic agent, an organic cosolvent, and a catalyst.

6. The article of claim 4 wherein the solid powder coating composition further comprises a thermosetting powder coating composition comprising a solid particulate mixture of
a) a film-forming resinous binder including i) a copolymer selected from the group consisting of epoxy, polyester and acrylic copolymers, and ii) a crosslinking agent capable of reacting with the copolymer,
b) one or more flow control agent, and
c) a catalyst.

7. The article of claim 4 wherein the at least one impregnated paper sheet further comprises a grass fiber.

8. A powder coated consolidated laminated article, comprising:
a plurality of paper sheets each impregnated with a substantially completely cured resinous composition, the plurality of impregnated paper sheets being assembled in superimposed relationship and heat and pressure consolidated into a consolidated laminated article; and
a film of a substantially completely cured solid powder coating composition laminated to at least a portion of an outer surface of the consolidated laminated article.

9. The article of claim 8, further comprising a film of an electrically charged primer applied to the outer surface of the consolidated laminated article;
wherein the solid powder coating composition further comprises a conductive additive constituent; and
wherein the substantially completely cured solid powder coating composition is further laminated to the film of electrically charged primer.

10. The article of claim 9 wherein the solid powder coating composition further comprises one of a thermoplastic powder coating composition, a thermosetting powder coating composition, and an epoxy thermosetting resin powder coating composition.

11. The article of claim 10 wherein the solid powder coating composition further comprises one or more additional constituents, wherein each of the one or more additional constituents is a constituent selected from the group of constituents consisting of a flow control agent, a dry flow agent, an antioxidant, a pigment, a matte texturizing agent, a light stabilizer, an optical brightener, an extender, an anhydride, an anti-popping agent, an anti-gassing agent, a thixotropic agent, an organic cosolvent, and a catalyst.

12. The article of claim 11 wherein the solid powder coating composition further comprises a thermosetting powder coating composition comprising a solid particulate mixture of
a) a film-forming resinous binder including i) a copolymer selected from the group consisting of epoxy, polyester and acrylic copolymers, and ii) a crosslinking agent capable of reacting with the copolymer,
b) one or more flow control agents, and
c) a catalyst.

13. The article of claim 11 wherein the at least one impregnated paper sheet further comprises a grass fiber.

14. A method of forming a powder coated consolidated laminated article, the method comprising:
in a thermal set resin compact laminate substrate comprising at least one paper sheet impregnated with a substantially completely cured resinous composition, applying to at least a portion of an outer surface of the impregnated paper sheet a film of a solid powder coating composition of a type that is substantially completely curable at temperatures less than about 500 degree F.;
substantially completely curing the powder coating composition at an elevated temperature less than about 500 degree F.; and
subsequently cooling the compact laminate.

15. The method of claim 14 wherein applying a film of a solid powder coating composition further comprises electrostatically applying the film of a solid powder coating composition, including: incorporating an electrostatic property-modifying agent into the coating composition, generating an electric potential between the coating composition and the substrate, and electrostatically attracting the coating composition to the substrate.

16. The method of claim 15, further comprising applying an electrically charged primer to at least a portion of an outer surface of the impregnated paper sheet prior to electrostatically applying the film of a solid powder coating composition.

17. The method of claim 16, further comprising incorporating into the powder coating composition one or more additional constituents selected from the group consisting of a flow control agent, a dry flow agent, an antioxidant, a pigment, a matte texturizing agent, a light stabilizer, an optical brightener, an extender, an anhydride, an anti-popping agent, an anti-gassing agent, a thixotropic agent, an organic cosolvent, and a catalyst.

18. The method of claim 15, further comprising forming the thermal set resin compact laminate substrate, including:
impregnating at least one paper sheet with a curable laminating resin composition;
partially curing the curable laminating resin composition;
assembling a plurality of impregnated paper sheets in superimposed relationship;
heat and pressure consolidating the impregnated paper sheets, including substantially fully curing the curable laminating resin composition; and
cooling the consolidated impregnated paper sheets.

19. The method of claim 18, further comprising applying the film of a solid powder coating composition prior to cooling the consolidated impregnated paper sheets.

20. The method of claim 19 wherein the impregnating at least one paper sheet with a curable laminating resin composition further comprises forming the at least one paper sheet of a grass fiber.
